(19) United States
(12) Patent Application Publication
(10) Pub. No.: US 2026/0229810 A1
(43) Pub. Date: Aug. 6, 2026

(54) MODULAR MULTI-TAP SYSTEM

(71) Applicant: Panduit Corp., Tinley Park, IL (US)

(72) Inventors: Andrew Crouse, Bolingbrook, IL (US); Jonathan Thompson, Woodridge, IL (US); Thuc K. Vu, Plainfield, IL (US); Rodney G. Rouleau, Lake Village, IN (US); Janina B. Nebes, Manhattan, IL (US); Philip W. Seils, Chicago, IL (US); David J. Sylvester, Manhattan, IL (US)

(73) Assignee: Panduit Corp., Tinley Park, IL (US)

(21) Appl. No.: 19/459,560

(22) Filed: Jan. 26, 2026

Related U.S. Application Data
(63) Continuation-in-part of application No. 19/328,463, filed on Sep. 15, 2025.
(63) Continuation-in-part of application No. 19/046,582, filed on Feb. 6, 2025.

(51) Int. Cl. H01R 13/514; H01R 25/00

(52) U.S. Cl. CPC H01R 13/514; H01R 25/003

(57) ABSTRACT

A modular multi-tap system has a plurality of modules wherein each module of the plurality of modules has a conductive metal block and an insulating housing. The insulating housing leaves the sides of uncovered. The conductive metal block has a common power conductor thru-hole which allows multiple modules to be ganged together by inserting the power common conductor through the thru-holes of all of the modules and then be engaged by setscrews in the modules.

### CROSS REFERENCE TO RELATED APPLICATION(S)

This application is a continuation–in-part of U.S. Patent Application serial No. 19/328,463, filed on September 15, 2025, which is a continuation-in-part of U.S. Patent Application serial No. 19/046,582, filed on February 6, 2025, the entirety of which is hereby incorporated by reference herein.

### FIELD OF INVENTION

The present disclosure relates generally to electrical muti-taps and more specifically to a modular muti-tap system.

### BACKGROUND

Multi-tap products are widely used in electrical infrastructure applications including solar applications. They can be found in ducts, troughs, raceways and boxes. Their main purpose is to connect several different wires that may be routed in different directions to a singular point. Wire conductors are inserted through wire port openings and held in place with a set screw.

Multi-taps have a minimum of two ports. Multi-taps with two, three and four ports are common, however there are some multi-taps with five, six, eight, ten, twelve and fourteen ports. The larger multi-taps are not used as often and therefore are not always in stock at a local distributor. In some applications, the amount of ports needed is not known until the installer arrives at the job site. In these cases, the installer needs parts in a very short time frame. If the required application requires more than four ports, the multi-tap may not be readily available.

### SUMMARY

A modular multi-tap system has a plurality of modules wherein each module of the plurality of modules has a metallic inner housing and a plastic outer housing. The plastic outer housing leaves the sides of the inner housing uncovered and has dovetail features which enable modules to be connected to each other in a manner that allows the uncovered sides of the inner housing to make metal-to-metal contact. The uncovered metallic sides may also have tongue and groove features to increase electrical contact.

### BRIEF DESCRIPTION OF THE DRAWINGS

FIG. 1 shows an isometric view of an inner aluminum housing.

FIG. 2 shows an exploded isometric view of an assembled module.

FIG. 3 shows an isometric view of two mating modules.

FIG. 4 shows the opposite isometric view of FIG. 3.

FIG. 5 shows a cross-sectional view of two mating modules.

FIG. 6 shows an isometric view of end-covers being added to the multi-tap.

FIG. 7 shows the opposite isometric view of FIG. 6.

FIG. 8 shows a cross-sectional view of fully installed multi-tap with wire.

FIG. 9 shows an isometric view of a fully installed multi-tap with wire.

FIG. 10A shows a front view of an expansion module of a second embodiment of the present invention.

FIG. 10B shows an isometric view of the expansion module of FIG. 10A.

FIG. 11 shows a front view of two expansion modules interlocked.

FIG. 12 shows an isometric view of an exploded assembly.

FIG. 13 shows a front view of the expansion module demonstrating bent tangs.

FIG. 14 shows a front view of two secured modules.

FIG. 15 shows an isometric view of two secured modules.

FIG. 16 shows an isometric view of two interlocked locking modules of a third embodiment of the present invention.

FIG. 17 shows an isometric view of a single locking module.

FIG. 18 shows an isometric view of two locking modules.

FIG. 19 shows an isometric view of the two locking modules of FIG. 18 beginning to be secured together.

FIG. 20 shows an isometric view of one of the mating fasteners of one of the locking modules of FIG. 18 being tightened.

FIG. 21 shows an isometric view of the two locking modules of FIG. 18 being secured together.

FIG. 22 shows how the turning of the mating fastener applies forces to secure two locking modules together.

FIG. 23 shows a conductor fastener being used to secure a conductor in an assembly of two locking modules.

FIG. 24 shows a second conductor being secured into the two locking module assembly of FIG. 23.

FIG. 25 shows a three locking module assembly with three secured conductors.

FIG. 26 shows an isometric view of a fourth embodiment of the present invention.

FIG. 27 shows an exploded isometric view of a conductor block with set screws.

FIG. 28 shows an isometric view of a conductor block with the setscrews retained within the block.

FIG. 29 shows an isometric view of a modular insulating housing for a conductor block.

FIG. 30 shows a conductor block retained within the modular insulating housing of FIG. 29.

FIG. 31 shows a common power conductor being inserted into a grouped set of modules.

FIG. 32 shows the end caps being secured to a ganged assembly.

FIG. 33 shows a finished ganged assembly.

FIG. 34 shows circuit conductors being inserted into a finished ganged assembly.

FIG. 35 shows a front view of a single conductor modular insulating housing for a modular multi-tap assembly.

FIG. 36 shows a top view of a single conductor modular insulating housing for a modular multi-tap assembly.

FIG. 37 shows a rear view of a single conductor modular insulating housing for a modular multi-tap assembly.

FIG. 38 shows a side view of a single conductor modular insulating housing for a modular multi-tap assembly.

FIG. 39 shows an isometric view of a single conductor middle section of a modular insulating housing viewed from the B-side.

FIG. 40 shows an isometric view of a single conductor middle section of a modular insulating housing viewed from the A-side.

FIG. 41 shows an isometric view of a single conductor A-side end cap.

FIG. 42 shows an isometric view of the single conductor A-side end cap of FIG. 41 viewed from the opposite direction.

FIG. 43 shows an isometric view of a single conductor B-side cap.

FIG. 44 shows an isometric view of the single conductor B-side end cap of FIG. 43 viewed from the opposite direction.

FIG. 45 shows an isometric view of a double conductor modular insulating housing for a modular multi-tap assembly.

FIG. 46 shows a front view of a double conductor modular insulating housing for a modular multi-tap assembly.

FIG. 47 shows a rear view of a double conductor modular insulating housing for a modular multi-tap assembly.

FIG. 48 shows a top view of a double conductor modular insulating housing for a modular multi-tap assembly.

FIG. 49 shows a side view of a double conductor modular insulating housing for a modular multi-tap assembly.

FIG. 50 shows an isometric view of a double conductor middle section of a modular insulating housing viewed from the B-side.

FIG. 51 shows an isometric view of a double conductor middle section of a modular insulating housing viewed from the A-side.

FIG. 52 shows an isometric view of a double conductor A-side end cap.

FIG. 53 shows an isometric view of the double conductor A-side end cap of FIG. 52 viewed from the opposite direction.

FIG. 54 shows an isometric view of a double conductor B-side cap.

FIG. 55 shows an isometric view of the double conductor B-side end cap of FIG. 54 viewed from the opposite direction.

FIG. 56 shows an isometric view of a fully assembled housing.

FIG. 57 shows to middle sections being secured together.

FIG. 58 shows the endcaps being secured to two middle sections.

FIG. 59 shows the endcaps being secured to two middle sections from the opposite view of FIG. 58.

### DESCRIPTION OF INVENTION

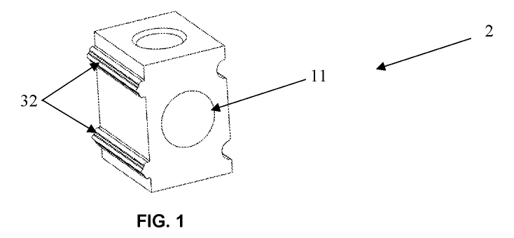

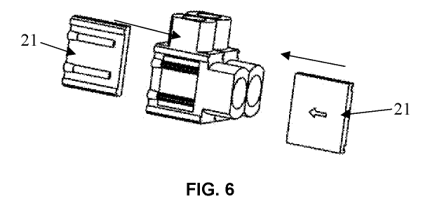

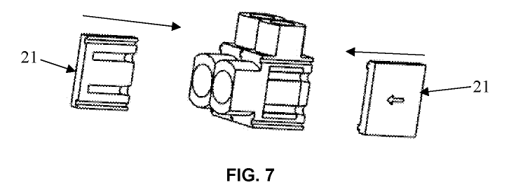

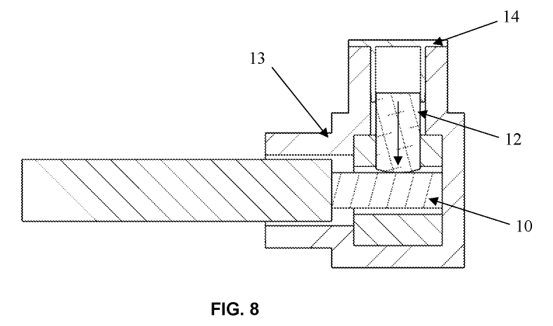

FIGS. 1-9 show a first embodiment of the present invention.

FIG. 1 shows an aluminum inner housing 2 with groove and tongue features 32, 34.

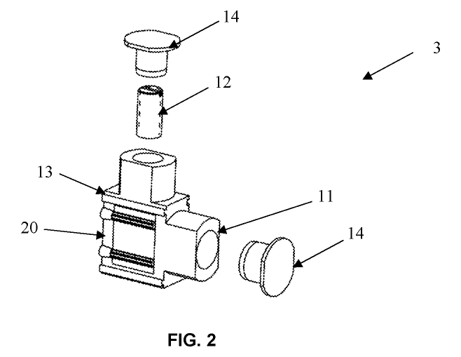

FIG. 2 shows an assembled module 3 in which the inner housing 2 is covered with plastic enclosures 13. The sides of the module (surfaces with the tongue and groove features) are not covered in plastic to allow for metal-to-metal contact between modules. Cap plugs 14 will keep out contaminates. Screw 12 will be used when installed with a wire. A plastic film, not shown, can be lightly adhered to the exposed aluminum to keep out contaminates.

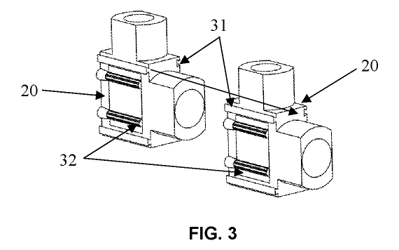

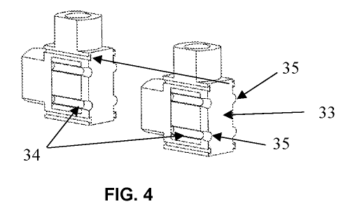

FIGS. 3 and 4 show two modules 3 being connected by sliding together. Cap plugs and screws are removed for clarity. The plastic enclosures 13 slide together with a dovetail arrangement 30, 31. The metal inner housings have tongues 32 that fit into a circular grooves 34. The tongue profile should have a minimum of two contact points for best electrical conductivity. The back of the plastic enclosure has a cone geometry 35. The cone geometry 35 in the end cover 21 will mate together to have a full contact surface to keep out dust and contaminates.

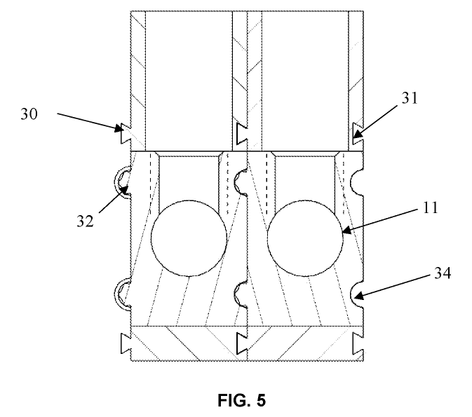

FIG. 5 shows the cross section of the two modules 3 together. This figure shows the interactions of the dovetail features 30,31 and the tongue and groove features 32, 34. FIGS. 6 and 7 show opposite views of end covers 21 being assembled to modular pieces 3. In the figures only two modular pieces are being installed together. But more than two modules may be assembled together in the present invention. Only one set of end covers would be required. One end cover will have the male tongue or dovetail which will fit on one end. The other side has the female grooves for the other end. Each part is assembled from one end of the port holes. These parts also have cone geometry ends that contacts the end cover.

The user can make any number of ports for the application with similar or different wire conductor size ranges. While the modular part shown in FIGS. 1 and 2 have one port, it is possible that one modular section could have multiple ports. Each part would consist of a normal modular assembly plus a set of end covers.

Wire conductors 10 are inserted through wire port 11 openings and held in place with a set screw 12. The screw will be 90 degrees from the wire ports. Aluminum is the main material used for multi-taps. The aluminum can be tin plated after machining though in some cases it may be preferable to be plated in gold, silver, or some other metal. Typically, the multi-taps are covered in clear or opaque plastic enclosure 13 in order to insulate the multi-tap. Cap plugs 14 are inserted into the port holes to keep out contaminates. The wire ports are drilled for the largest conductor size, but smaller conductors can fit in them as well.

Two sides of the module 3 will have bare metal and not covered in plastic. In order for electricity to conduct between the modules, the surfaces must be metal-to-metal. More contact area is preferred. The metal-to-metal contact can be enhanced with tongue and groove features 32, 34. The plastic pieces can have a traditional dovetail 30, 31 feature. The metal-to-metal part ensures there are some rounded edge points of contact between the metal parts. The plastic-to-plastic parts are aligned to ensure the modules are held together tightly. The tight fit in the dovetail feature is to keep out dust and other contaminants while providing an electrical insulated part. The back end 33 of the plastic interfaces have chamfered sides that will ensure a tight fit. After the desired number of modules are installed, end covers are slid on to the side of the modules to ensure the metal surfaces are not exposed.

FIGS. 10A, 10B and 11-15 show a second embodiment of the present invention.

The expansion modules 110 can be made of aluminum and are typically plated with tin, silver or gold to increase conductivity and reduce corrosion over time. An example of an individual module is shown in FIGS. 10A and 10B. The expansion modules 110 will have a female threaded hole 111 for a set screw 120 with a hex or slotted drive. There is a through or wire port 112 hole for a wire conductor 121 to be inserted. A gap 113 between the male tangs 114 is used to deform under force and provide a connection. The gap 113 should be big enough for deflection to occur, but small enough that smaller wire or wire strands from the conductor 121 come out of the wire port. Multi-taps have a plastic insulation around them to protect personnel, property and mounting points. For this disclosure, the plastic housing does not affect the concept of the expansion connection and may not be shown in illustrations.

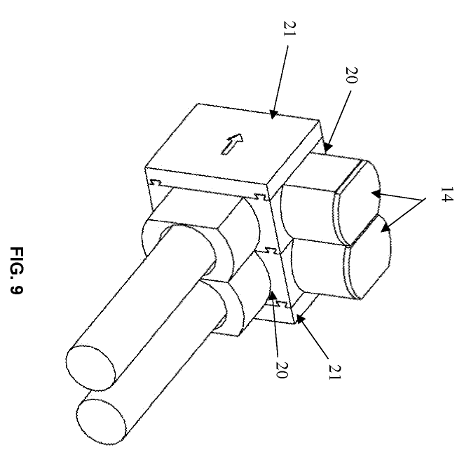

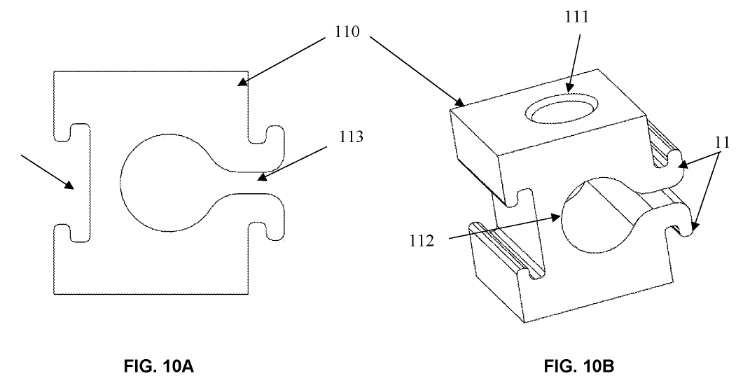

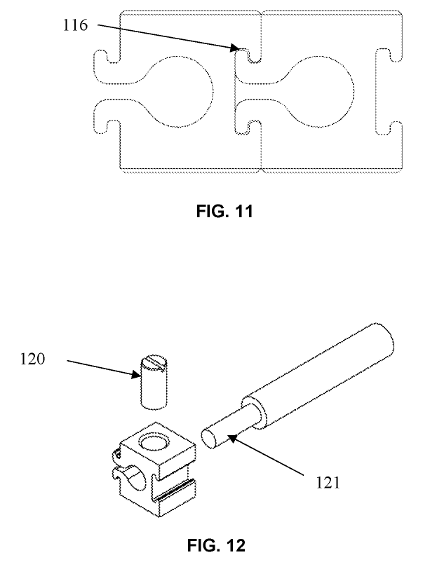

There are male tangs 114 on the side of the gap opening 113. They fit into the rectangular opening 115 on the other side of a second expansion module. The fit is loose with some distance 116 between opening and tang. See FIG. 11 for an example.

For assembly, the end of the wire is stripped to a predetermined length. The wire end is inserted into the wire port 112. The screw is threaded until a predetermined torque is reached. The force imparted on cable also imparts force onto the module. The gap 113 allows the two tangs 114 to expand out in different directions. The tangs then contact the opening and make a solid connection. Multiple modules can be used to make a plurality of connections in the system. Loosening a screw will allow a module to be removed if desired as the deformation is not permanent.

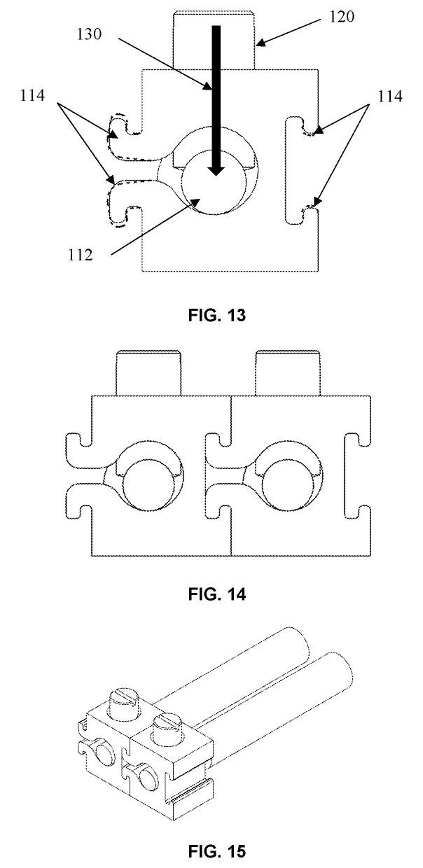

FIG. 13 shows the force 30 imparted by the screw onto the wire conductor 121. The gap 113 weakens the block and allows for it to bend. The male tangs 114 expand out and the opening 115 caves in. FIG. 14 shows assembled blocks with the tangs contacting each other to create a solid mechanical and electrical connection.

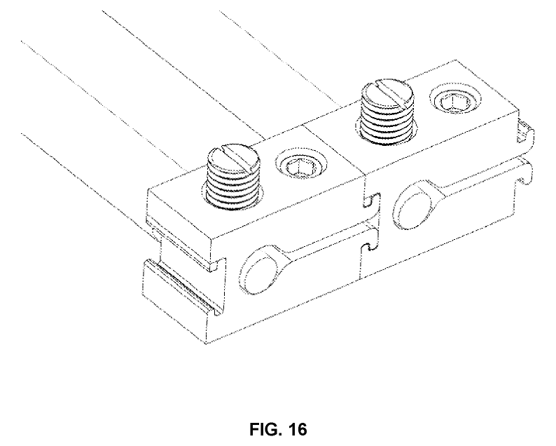

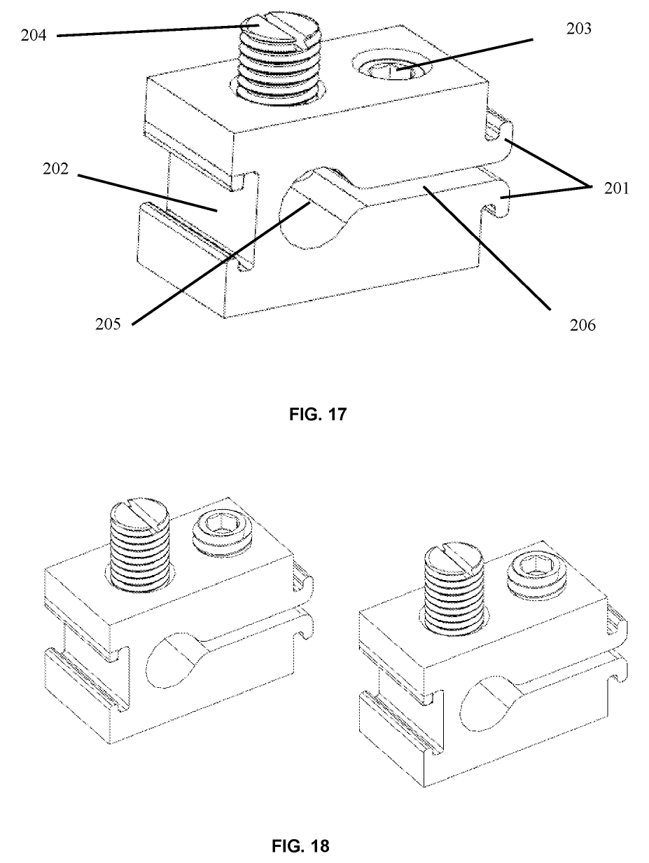

FIGS. 16-25 show a third embodiment of the present invention. This embodiment utilizes an independent mating fastener 203.

These figures show a locking module having a male mating section 201, female mating section 202, mating fastener 203, conductor fastener 204, conductor chamber 205, and mating yolk 206. The locking modules can be ganged together male to female to create a terminal block with enough positions required to secure multiple conductors.

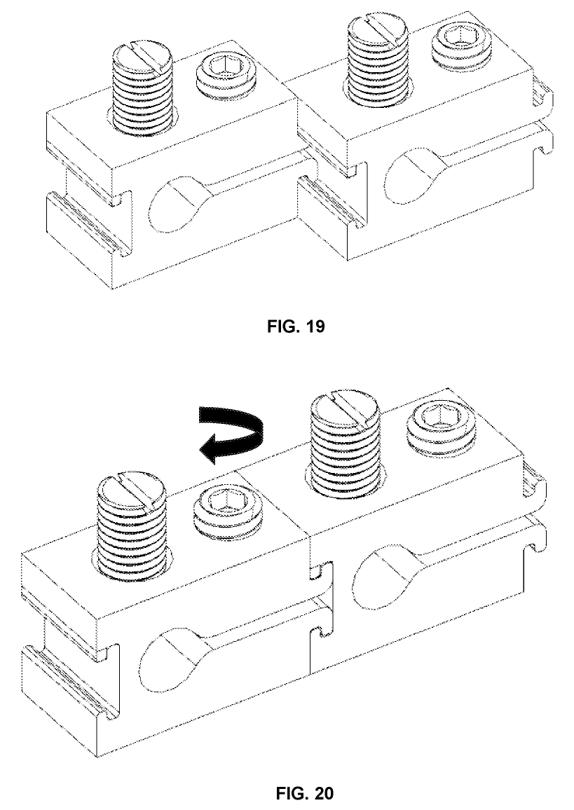

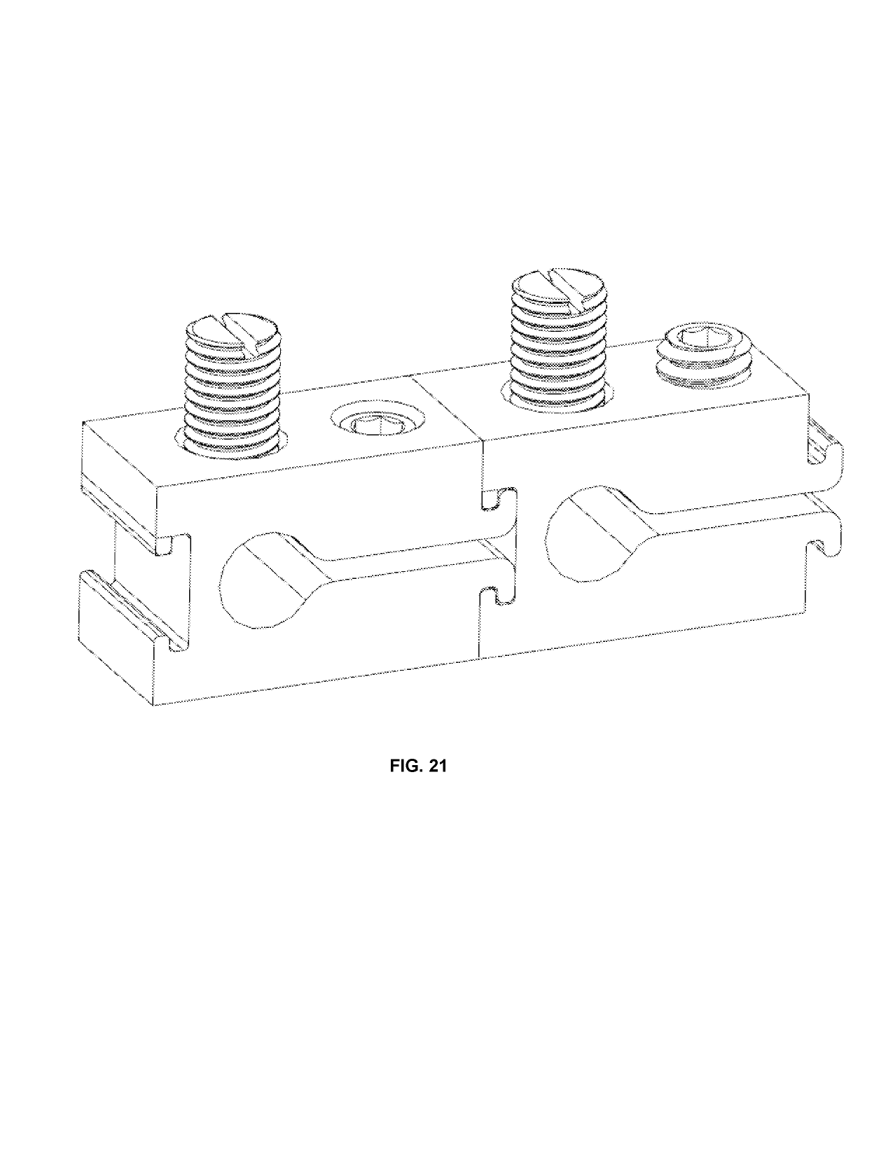

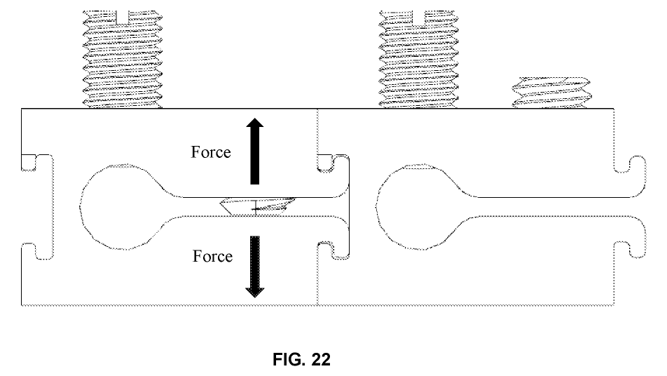

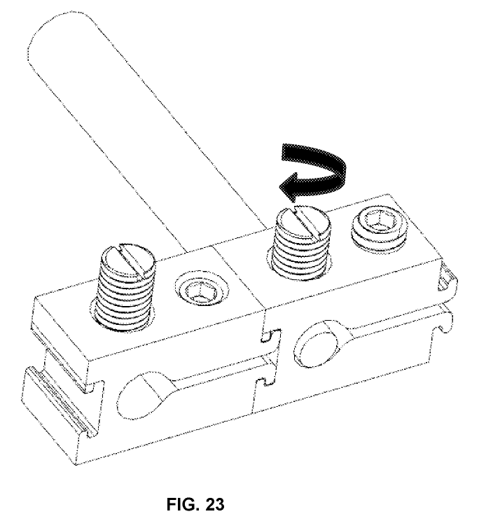

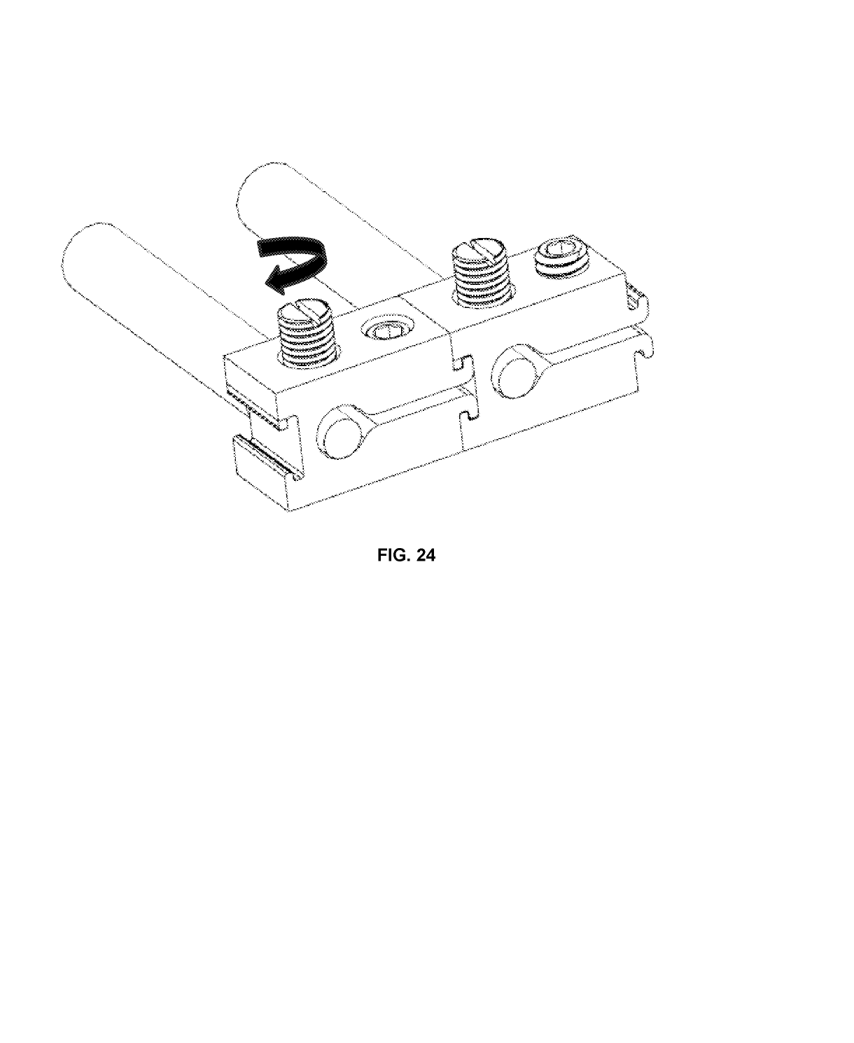

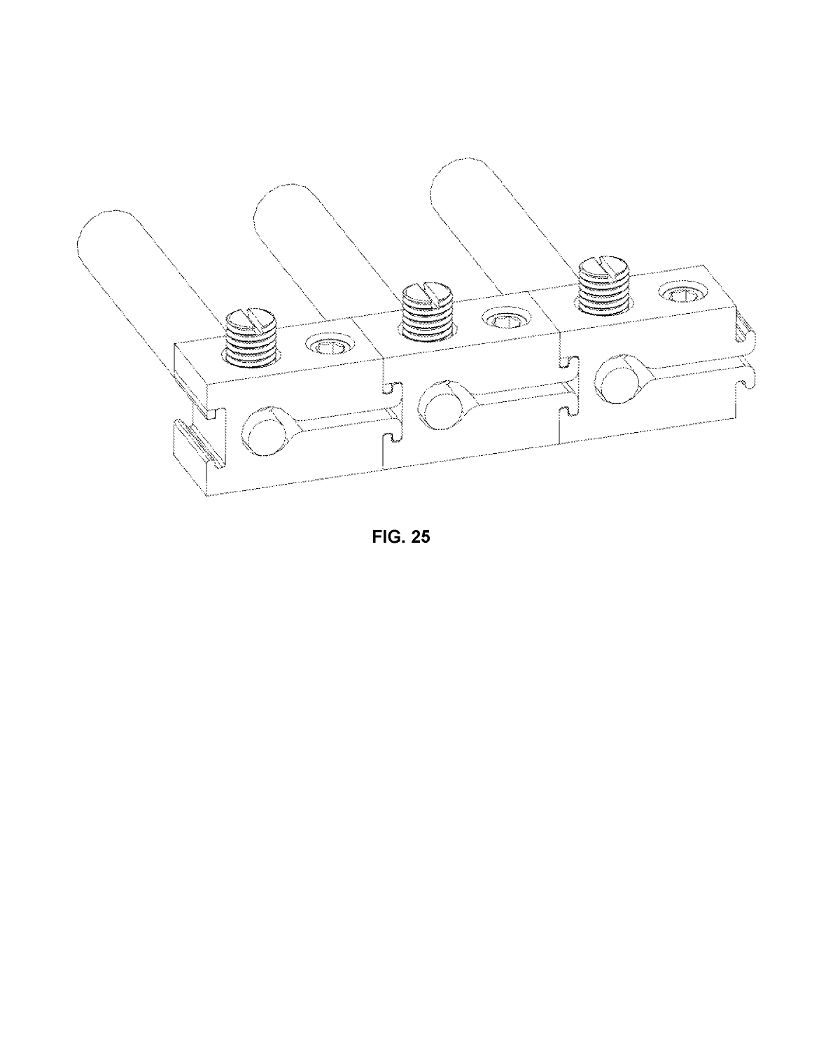

The locking module ganging process starts with the mating fastener 203 outside of the yolk 206 and the conductor fastener 204 outside of the conductor chamber 205 (see FIG. 18). The locking modules are assembled with the male mating section 201 sliding into the female mating section 202 (see FIGS. 19 and 20). When the locking modules have been mated the mating fastener 203 is tightened to lock the modules together (see FIG. 21). The mating fastener spreads the yolk slightly by applying a force to the bottom yolk surface. The equal and opposite is force is applied to the upper yolk via the mating fastener threads (see FIG. 22). The slight spreading of the yolk locks the female mating and male mating sections mechanically and electrically. The next step is to install the conductors and tighten the conductor fasteners (see FIG. 23 and 24). The number of ganged terminal blocks can be increased as required (see FIG. 25).

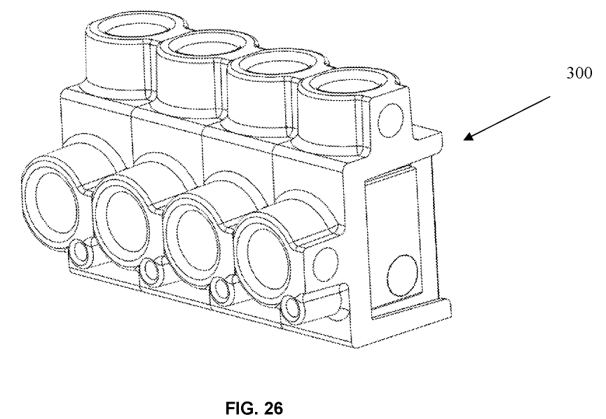

FIG. 26 shows a fourth embodiment of the present invention 300. The fourth embodiment is a gangable terminal block with a common power conductor. This embodiment has terminal block modules 305 consisting of a conductive metal block 310 with a circuit conductor thru hole 311, a common power conductor thru hole 312, a circuit conductor setscrew threaded hole 313, a common power conductor setscrew threaded hole 314, a common power conductor setscrew 315, and a circuit conductor setscrew 316 (see FIGS. 27 and 28).

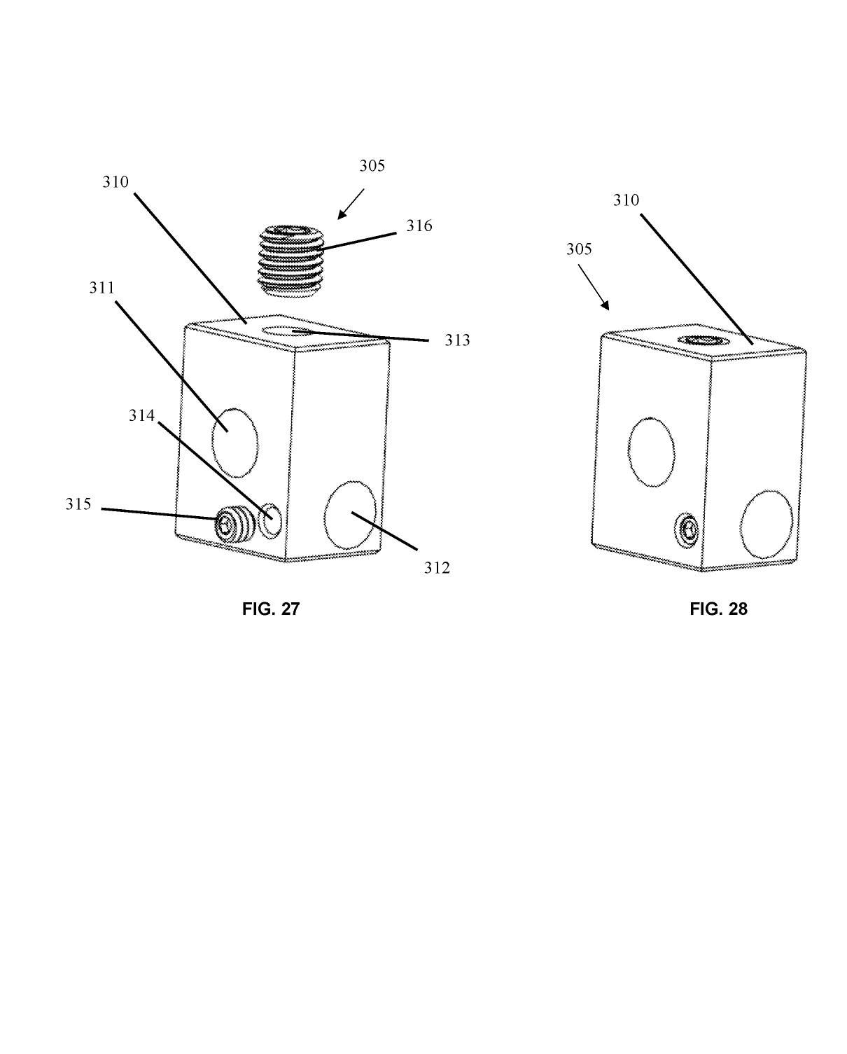

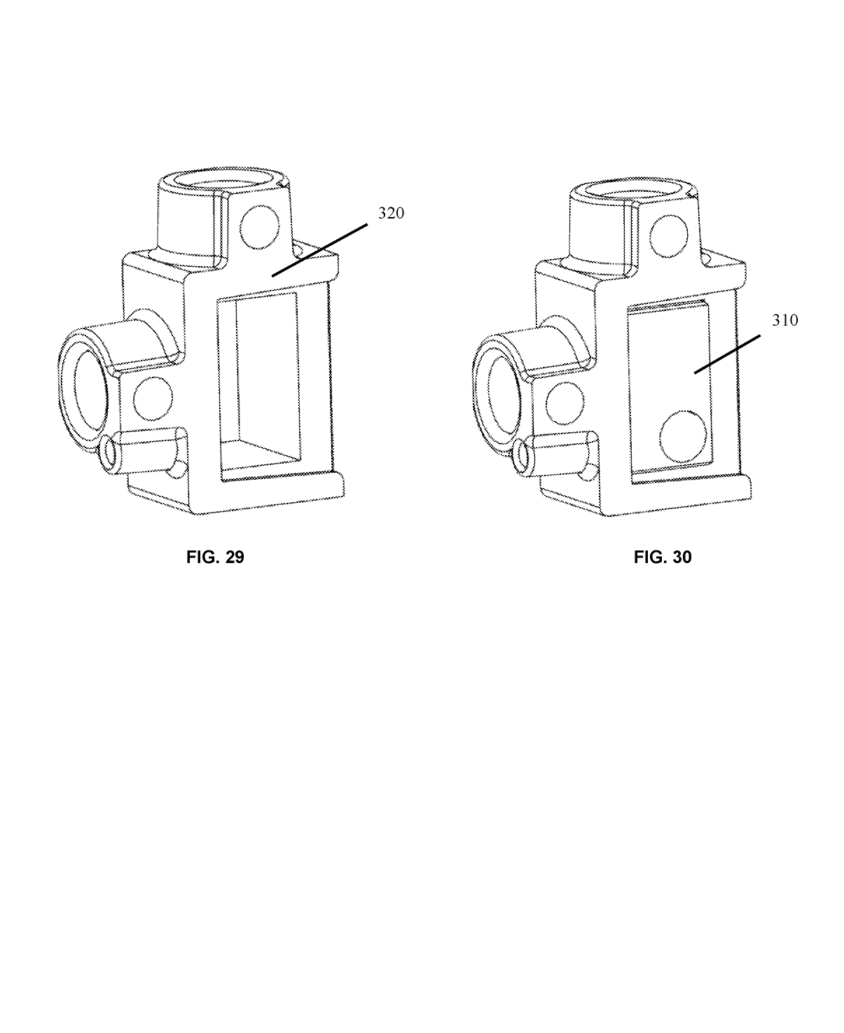

Each conductive metal block 310 is surrounded on four sides with a linkable multi-tap housing 320 (see FIG. 29). The linkable multi-tap housing is an insulator and has openings for a conductor(s) and setscrew tool access.

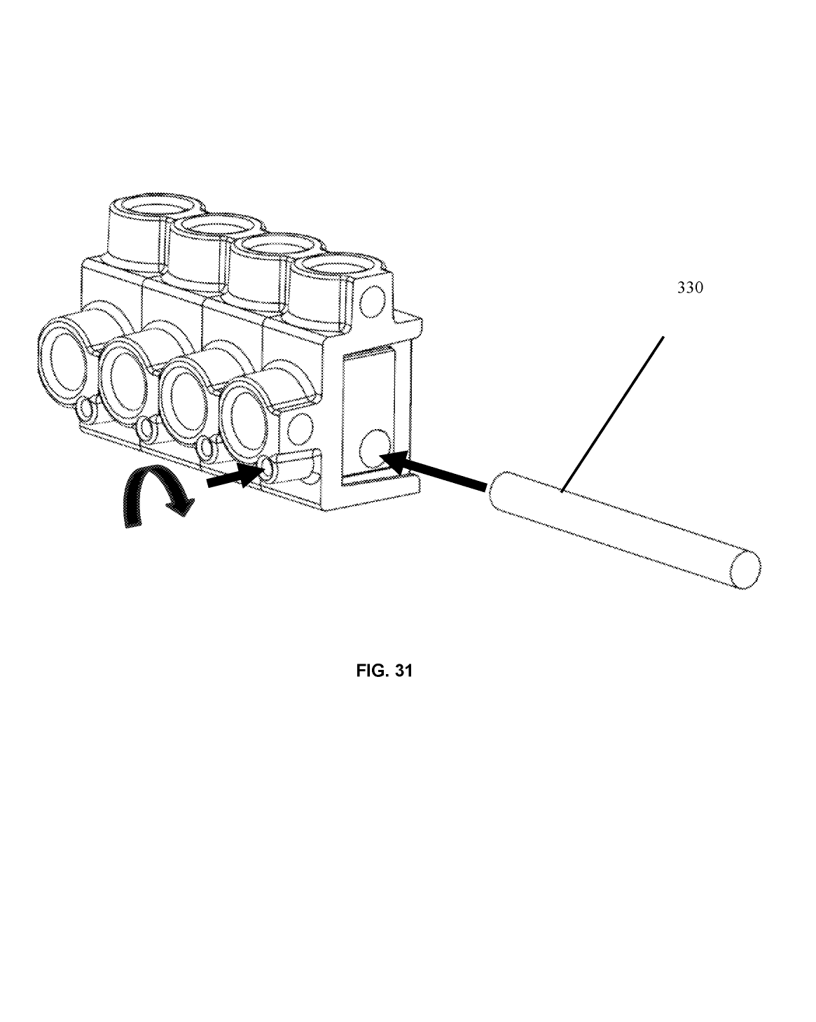

The conductive metal block/linkable multi-tap housing assemblies are ganged together with two or more multi-conductor terminal blocks 310. When the desired number of blocks have been ganged together, a common power conductor 330 that equals the length of multi/conductor terminal block is inserted into the common power conductor thru hole for each of the conductive metal blocks in the gangable multi-tap (see FIG. 31). Once the common power conductor has been installed into all the blocks the common power conductor setscrew of every block is tightened. The common power conductor is sized to match the current rating of the largest conductor approved for use in the terminal blocks. The side end cap 340 is installed to cover the exposed metal (see FIG. 31). A complete terminal block assembly is shown in FIG. 32.). The circuit conductors are inserted into the circuit conductor thru holes (see FIG. 33). The setscrews are then tightened to a specified torque the same as any other electrical termination.

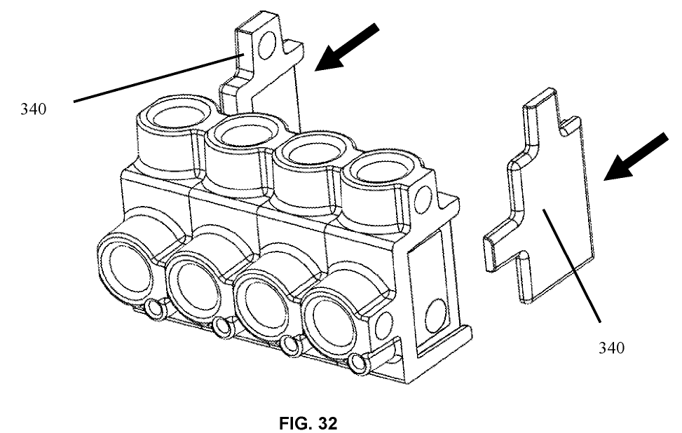

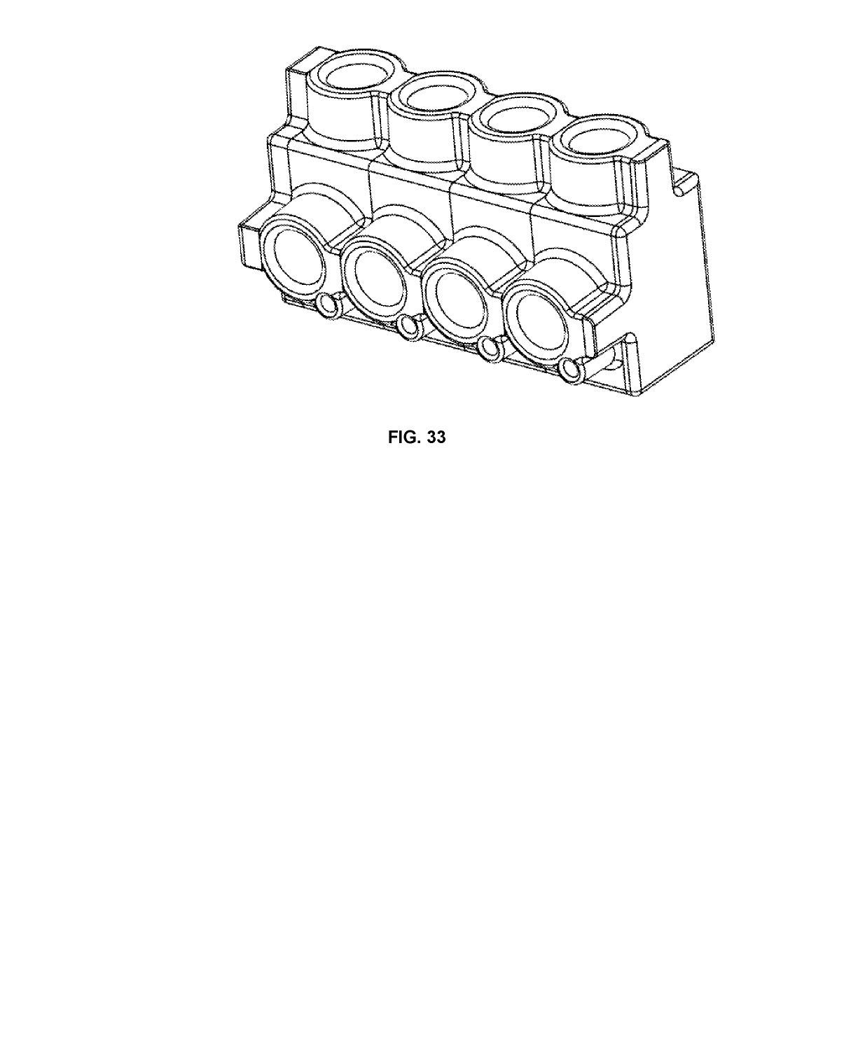

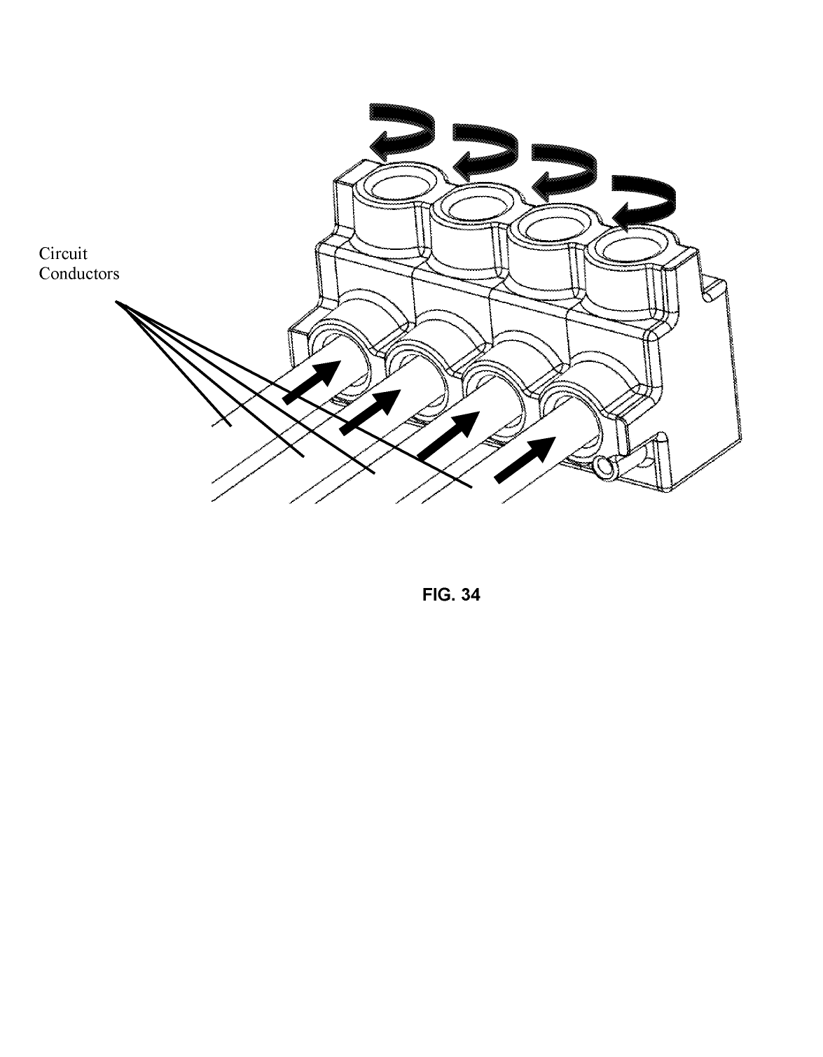

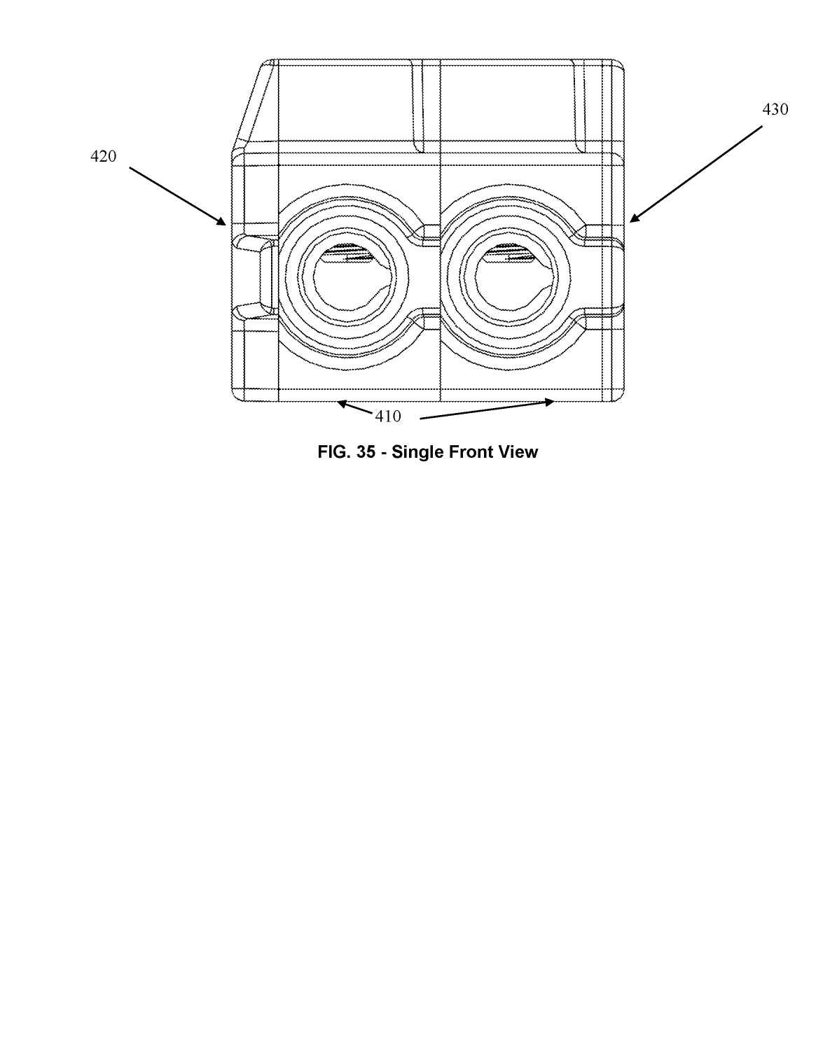

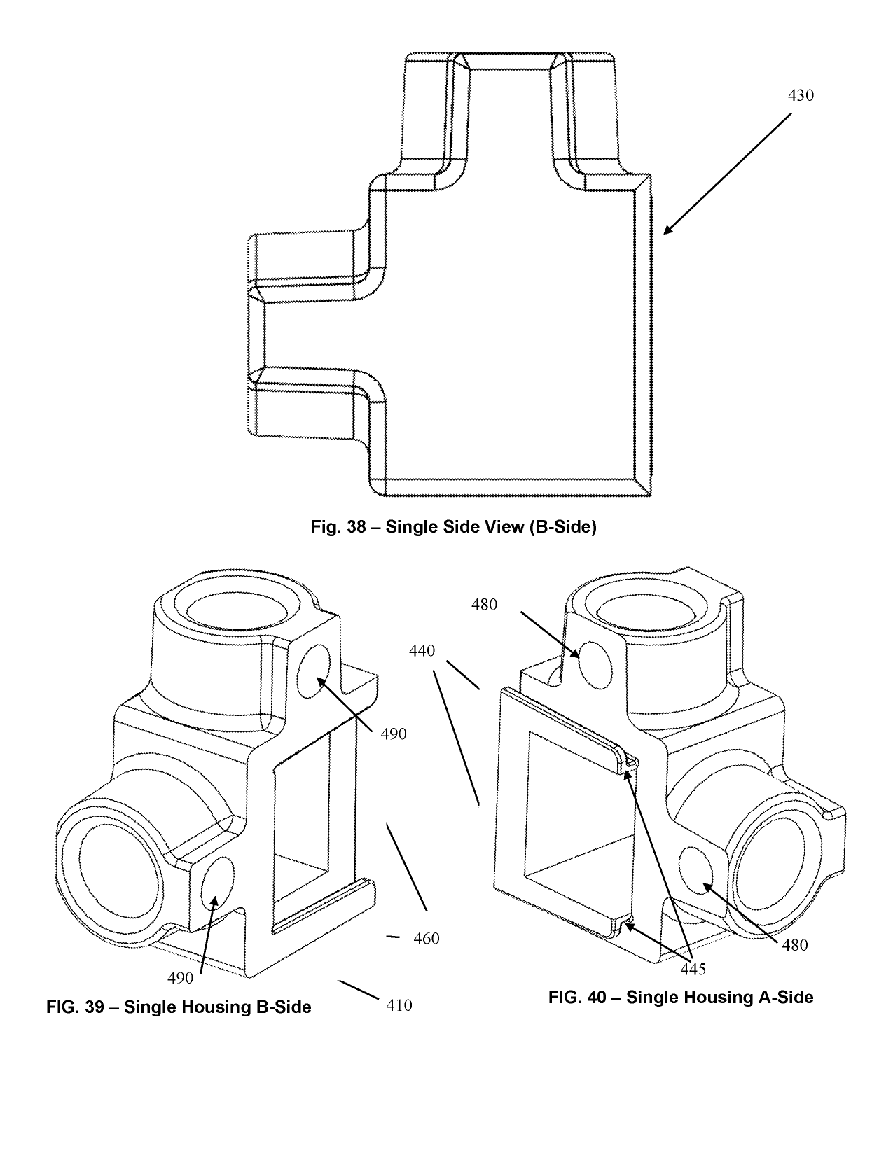

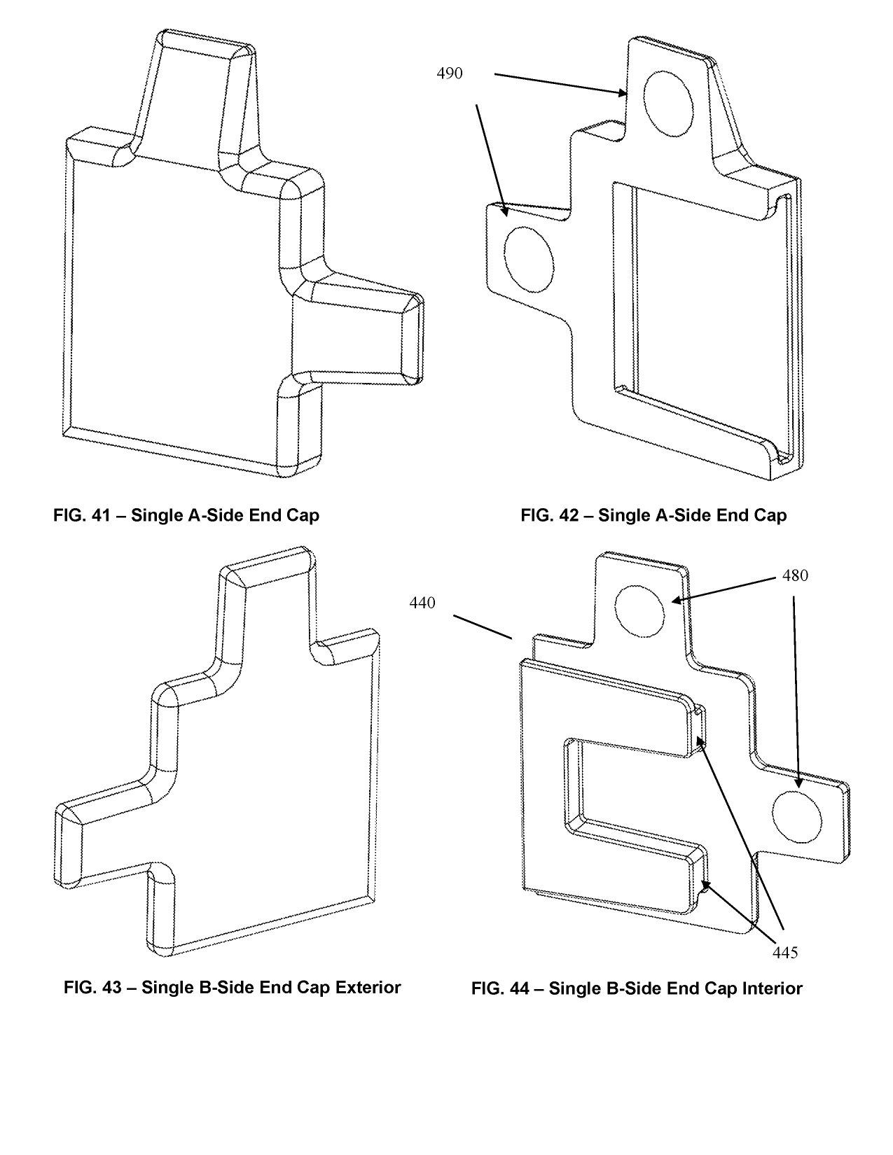

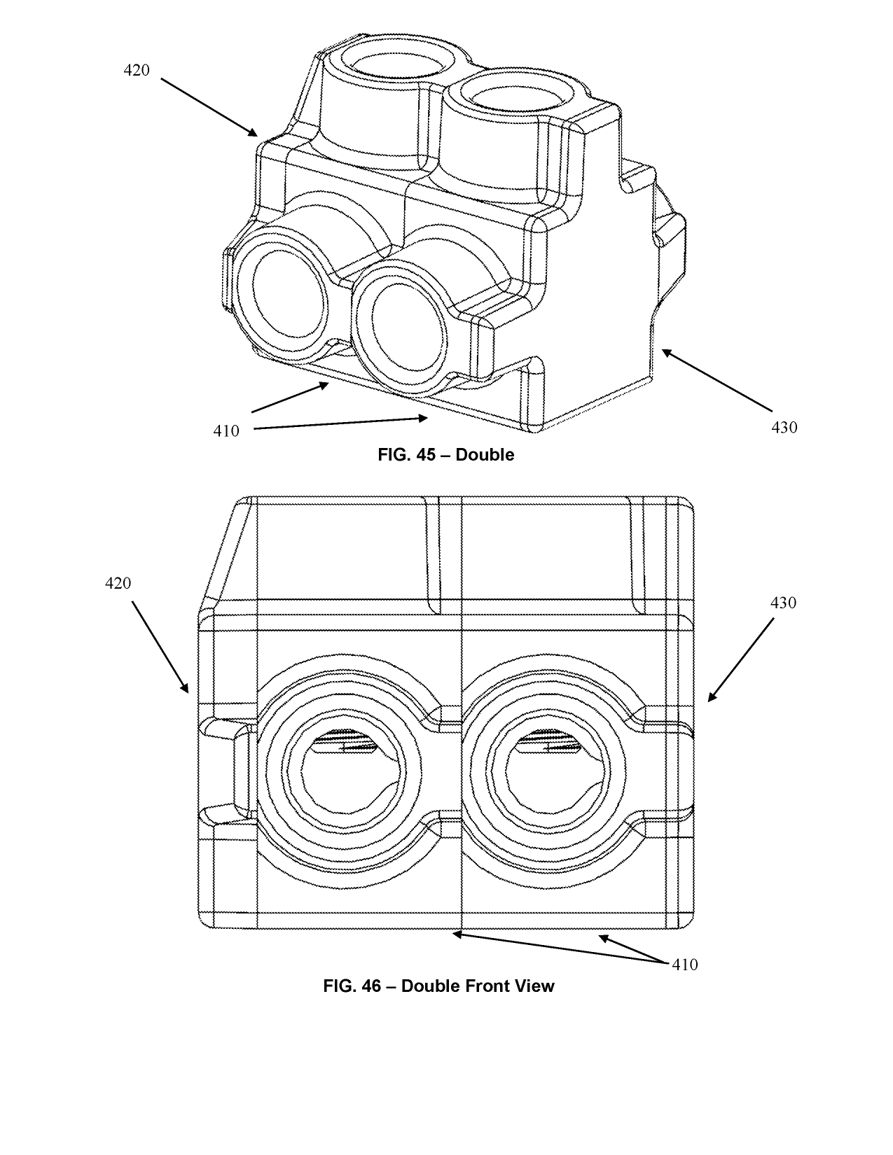

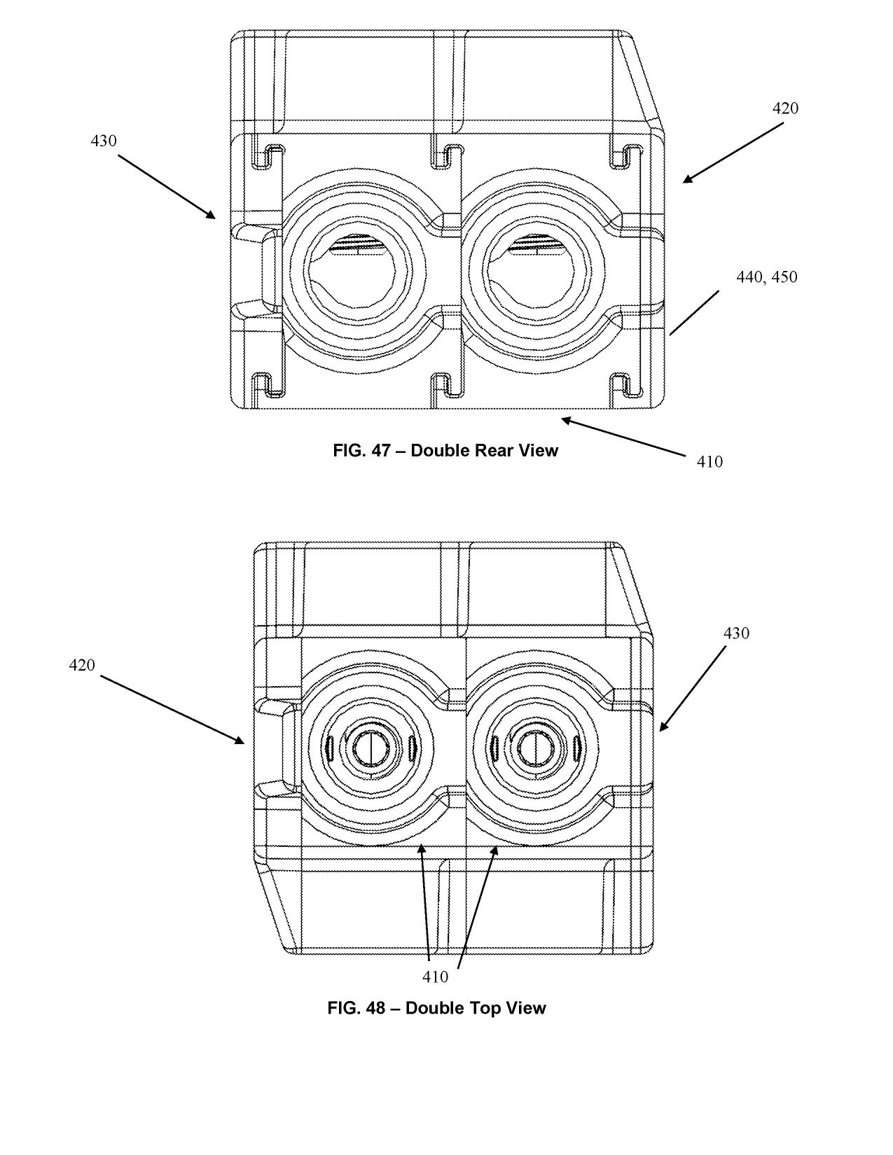

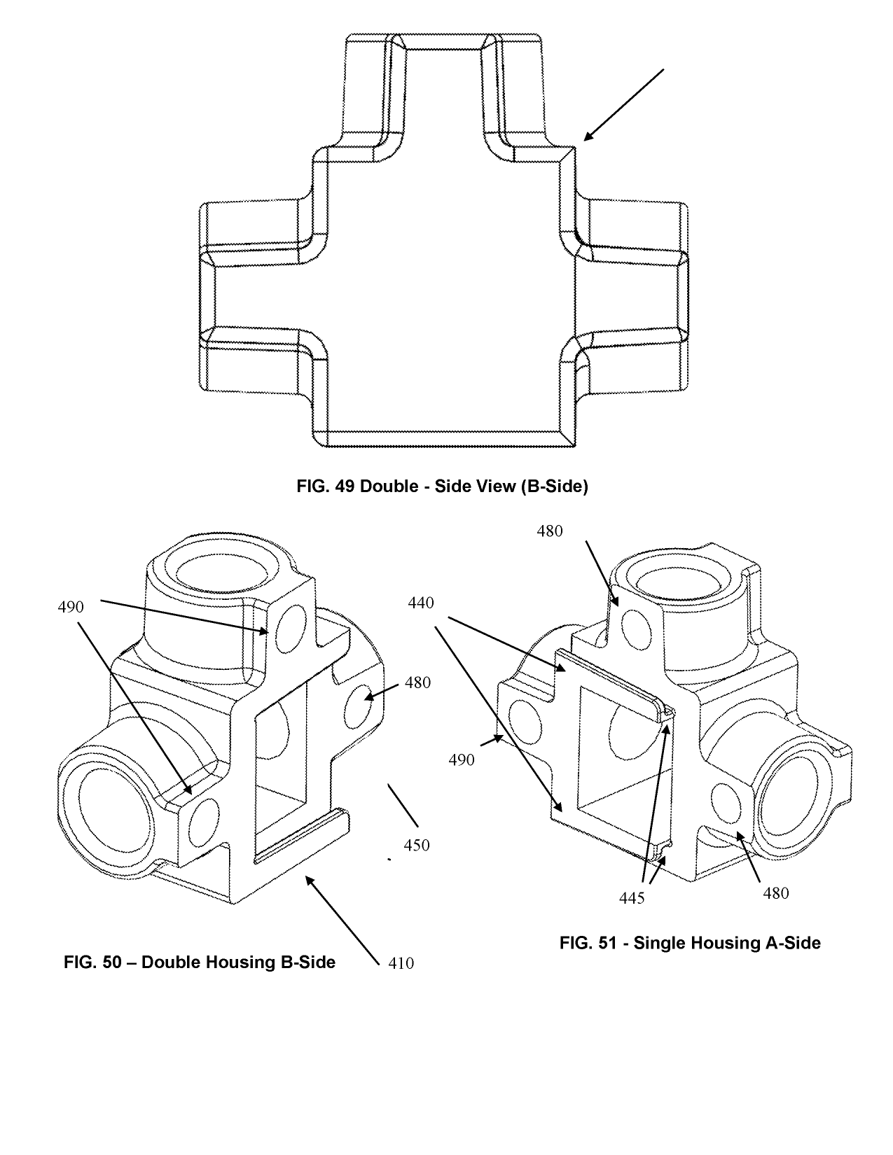

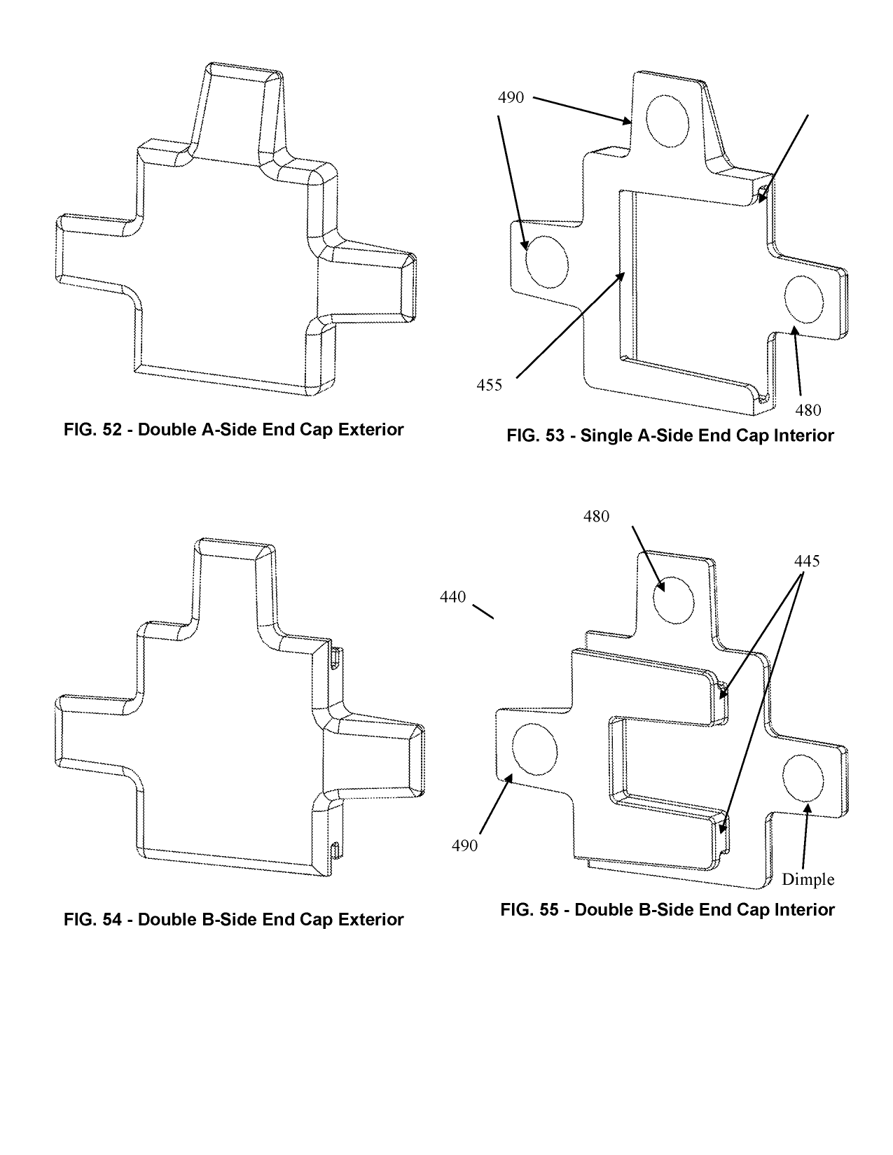

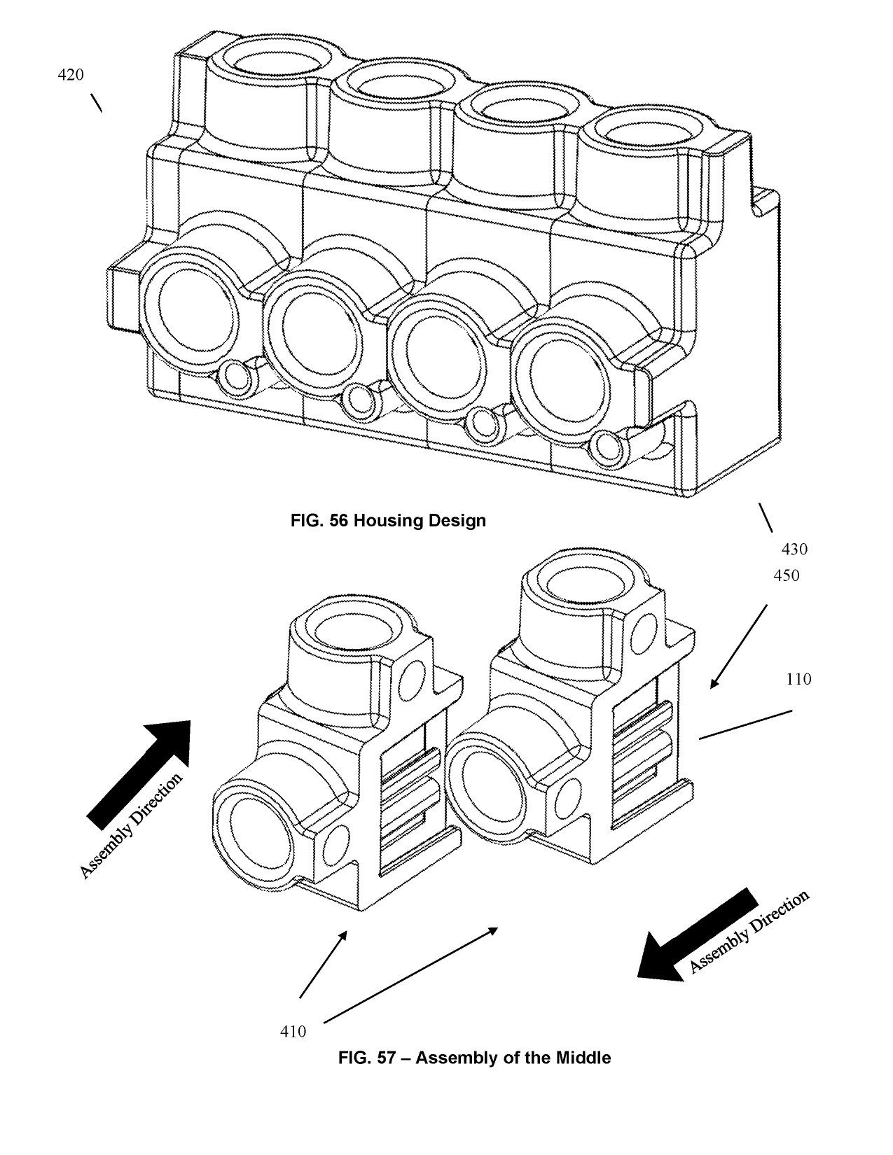

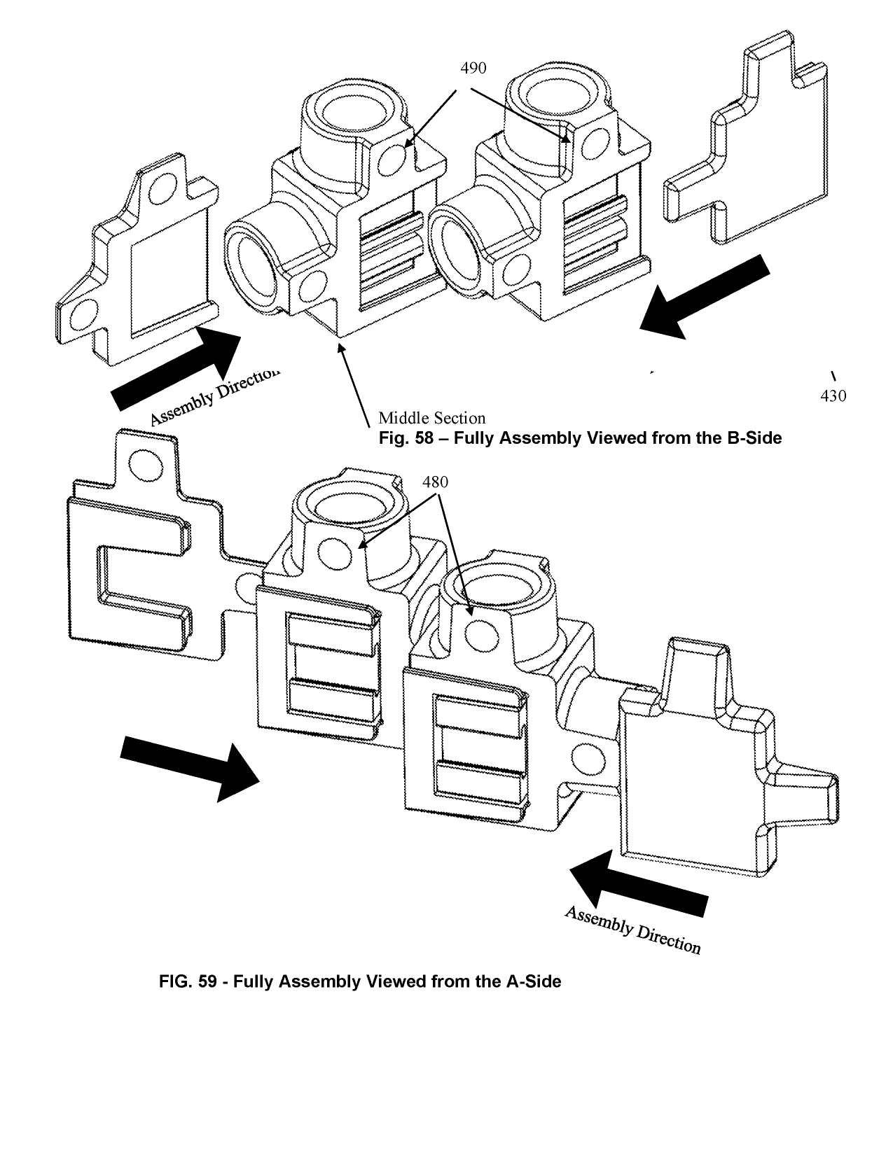

FIGS. 35-59 show a modular housing 400 that can be used with the present invention. This insulation housing can consists of three unique parts; a middle section 410 (see FIGS. 35-37, 39, 40, 45-48, 50, 51, and 56-59), an A-side end cap 420 (see FIGS. 35-37, 41, 42, 45-48, 52, 53, 56, 58, and 59) ,and a B-side end cap 430 (see FIGS. 36-38, 43, 44, 45-48, 54, 55, 56, 58, and 59). The middle section 410 can either be linked to other middle sections (see FIGS. 57-59), or the end caps 420, 430 (see FIGS. 58 and 59). Where the middle sections are linked together, two as the minimum, and the end caps terminating the ends of the linked chain of multi-tap blocks.

Each middle section can contain expansion module 110 (while the figures show the use of the expansion module 110 from the second embodiment, the housing could also be used with a module 3 from the first embodiment, the locking module of the third embodiment, or the terminal block 310 of the fourth embodiment). The various set screw and conductor pass through holes in the modules or terminal blocks are aligned with the respective shroud openings in the housing’s middle section (see FIGS. 35-40 & 45-51). This allows access to the set screw(s) and ports on module or terminal block while being insulated by the housing on four of the six faces. With this done the now assembled bus bar block with setscrew(s) inside the housing middle section forms a complete part number that would be ordered by customers.

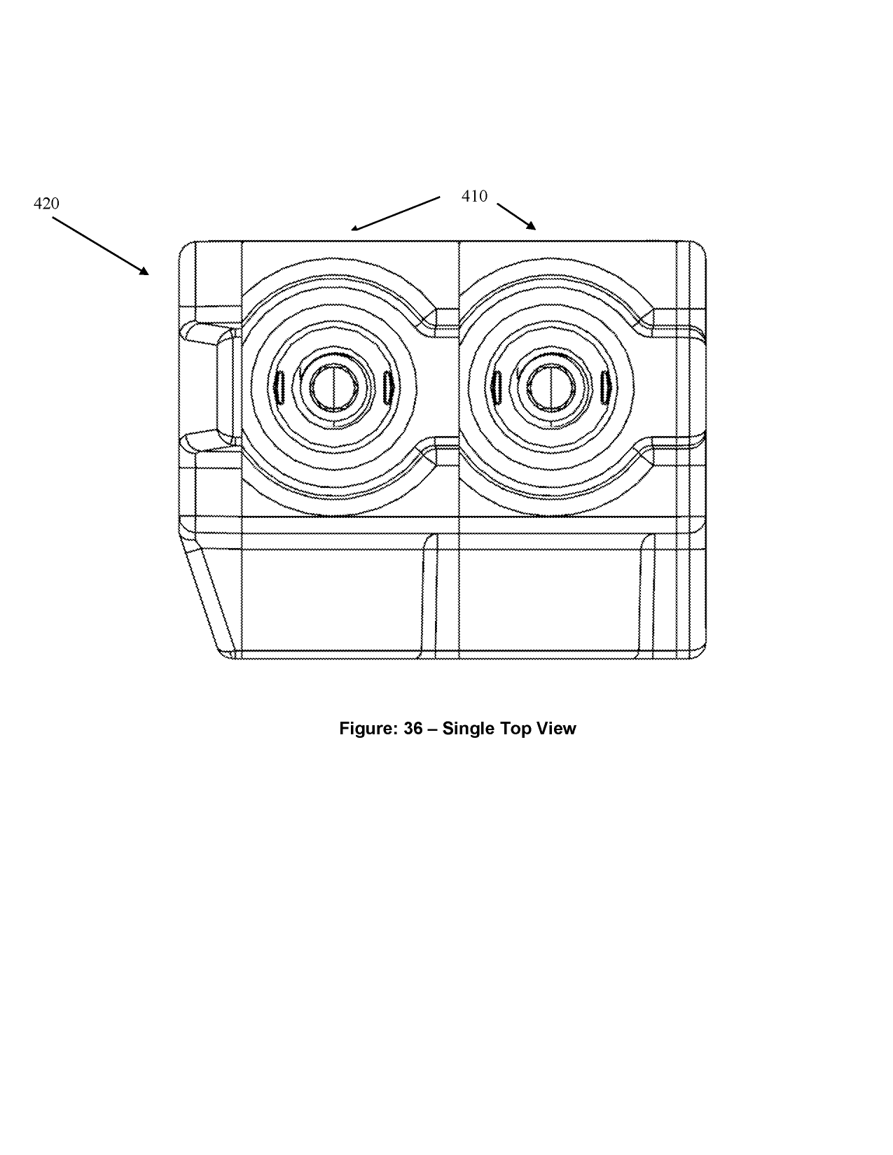

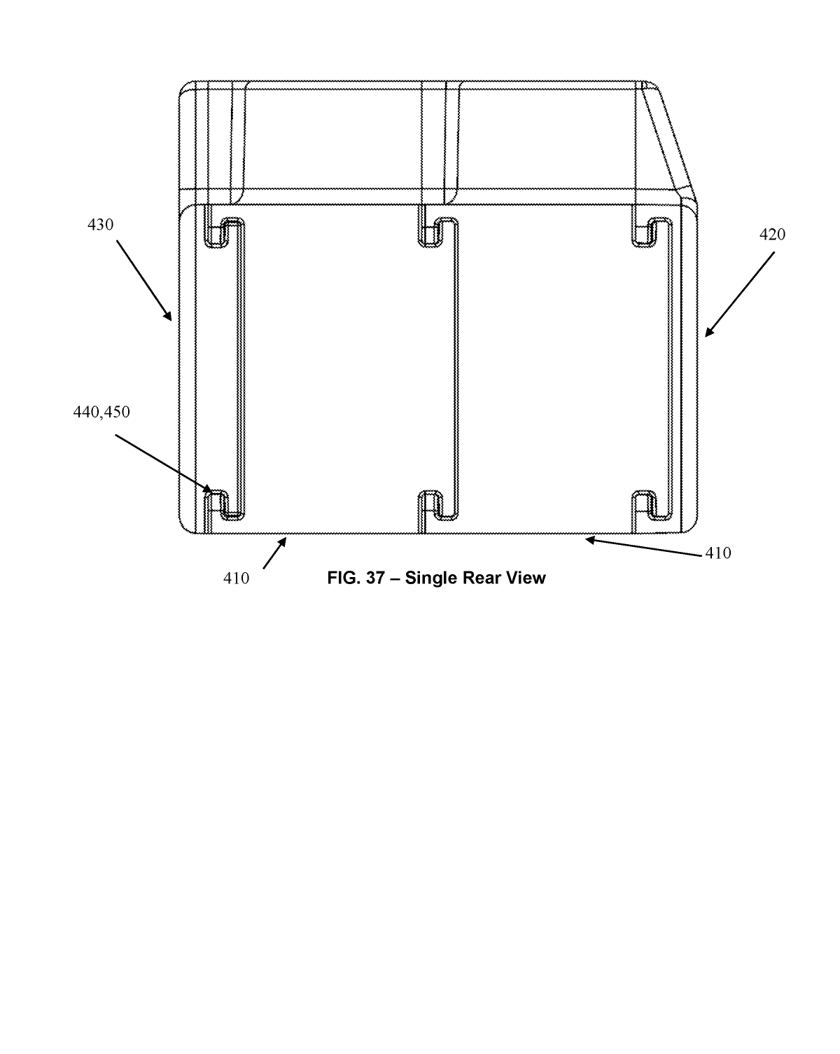

The module and middle section housing assemblies are ganged together, with two being the required minimum, other module and middle section housing assemblies, to form a chain of linked assemblies up to the desired number of gangs. This is achieved by taking those assemblies and sliding them together so that the male and female stopped lock rabbet joints 440, 450 (see FIGS. 37, 39, 40, 42, 44, 47, 50, 51, 53, 55, and 57-59) fit together and act as a guide track with an end stop 445 (see FIGS. 40, 42, 44, 51, 53, and 55). The joints are stopped to prevent the assemblies from sliding past each other by providing a physical barrier for the slide stops (See FIGS. 7, 11, 18 & 22) on the male side of the lock rabbet joints 440 (see FIGS. 40, 44, 51, 55, and 59) to butt up against, allowing for proper alignment between the assembles so that the mating features on the modules 110 align. The lock rabbet part of the joint also prevents the assemblies, mainly the housings, from being pulled apart, via stretching along the length of the chain, via the mating undercuts on the male and female sides of the lock rabbet joint, (see FIGS. 40, 42, 44, 51, 53, and 55). Those undercuts function as stops that prevent those housings from being pulled apart, but not the bus bar. While the bus bar provides the core strength of the assembly’s ability to resist being pulled apart, the undercuts on the housing do not have the strength to resist excessive pulling force.

Those same undercuts also ensure that the bus bar is properly insulated, by being forced to partially interfere with each other (see FIGS. 37 and 47). Creating a near solid wall of plastic concealing the metal terminal block with little to no air gaps for an electrical arch to escape. The same joint type is utilized on the end caps (see FIGS. 35-38, 41-44, 45-49, 52-56, 58 and 59) to maintain the same level of insulation at the ends of the multi-tap chain.

The housing and end caps also utilize a low force retention and locating feature of a dimple 480 and recess 490 (see FIGS. 39, 40, 42, 44, 50, 51,53, 55, 58, and 59) to hold the components in place. They will only work if the housing and end caps are properly assembled, i.e. pushed all the way up against the stops. This feature exists to eliminate the need for any additional tools or hardware to secure the plastic components together and prevent them from being easily disassembled. It also provides peace of mind by not only providing physical reassurance, by requiring the installer to apply some force to push the parts together during assembly, but also makes an audible click sound when the components are properly mated.

Given a complete middle section assembly (see FIGS. 24-26). The end user will then link middle section assemblies by sliding them together via the stopped lock rabbet joints and overcoming the slight locking force of the mating dimple and recess. This action will be repeated until the desired number of middle sections are linked together. Then both the A and B side end caps will be installed, on the appropriate ends of the linked chain, via the same sliding method that was used for linking the middle sections together. From there the circuit conductors are inserted into the circuit conductor through holes via the conductor shrouds (see FIGS. 35-40 and 45-51). Then the setscrews are then tightened to the specified torque in the same manner as any other electrical termination

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A modular multi-tap system comprising a plurality of modules wherein each module of the plurality of modules includes a conductive block with a common power conductor thru-hole.

2. The modular multi-tap system of claim 1, further comprising a common conductor threaded setscrew hole that accesses the common power conductor thru-hole such that tightening a setscrew within the common power conductor setscrew thru-hole causes the setscrew to engage a common power conductor inserted into the common power conductor thru-hole.

3. The modular multi-tap system of claim 2, further comprising a modular insulating housing partially surrounding each module and having features allowing adjacent portions of the modular insulating housing to engage each other.

4. The modular multi-tap system of claim 3, wherein the features allowing adjacent portions of the modular insulating housing to engage each other are rabbet joints.

5. The modular multi-tap system of claim 4, further comprising dimple and dimple recess features that engage each other when portions of the modular insulative housing are secured together.

6. A modular insulating housing for a modular multi-tap system comprising at least one middle section and a pair of end cap sections with features which allow a middle section to engage another middle section or an end cap section.

7. The modular insulating housing for a modular multitap system of claim 6, wherein the features allowing adjacent portions of the modular insulative housing to engage each other are rabbet joints.

8. The modular insulating housing for a modular multitap system of claim 6, further comprising dimple and dimple recess features that engage each other when portions of the modular insulative housing are secured together.
